(19) United States
(12) Patent Application Publication
(10) Pub. No.: US 2025/0319936 A1
(43) Pub. Date: Oct. 16, 2025

(54) BICYCLE CLAMPING DEVICE

(71) Applicant: HAIDONG GU, Montclair, CA (US)

(72) Inventor: HAIDONG GU, Montclair, CA (US)

(21) Appl. No.: 18/636,282

(22) Filed: Apr. 16, 2024

(51) Int. Cl. B62H 3/02

(52) U.S. Cl. CPC B62H 3/02

(57) ABSTRACT

The bicycle clamping device of the present invention comprises: a tube assembly having a first tube and a second tube; a first quick-release assembly connected to a first connecting portion at one end of the first tube and having a first handle and a first transmission shaft rotatable with the first handle and having one end pivotally connected to the first handle and the other end inserted into the second tube; a positioning assembly, movable synchronously with the first transmission shaft and having a second positioning portion for mutual positioning with a first positioning portion at the other end of the first tube; a clamping assembly mounted to one side of the second tube, allowing synchronous rotation of the second tube and the clamping assembly through the first transmission shaft when rotating the first handle; and a stand assembly pivotally mounted to a bottom side of the tube assembly.

### BACKGROUND OF THE INVENTION

### Fields of the Invention

The present invention relates to a technical field of bicycle maintenance and, more particularly, to a bicycle clamping device.

### Descriptions of Related Art

Existing bicycle maintenance workbenches mostly can only clamp bicycle frame tubes between the movable clamping portion and the fixed clamping portion, and raise the bicycle to a certain height for maintenance. However, this type of structure does not have the function of adjusting the angle of the movable clamping portion and the fixed clamping portion according to the bicycle. Consequently, maintenance personnel may need to change their posture, such as bending, to perform maintenance tasks when dealing with specific angles. This not only has poor practicality but also easily leads to the risk of injury to the maintenance personnel during the maintenance process.

### SUMMARY OF THE INVENTION

The present invention provides a bicycle clamping device. A primary objective is to provide a mechanism for coaxial rotation of the clamping assembly and the first handle, allowing the clamping assembly to rotate with the rotation of the first handle and achieving rapid clamping of bicycle frame tubes.

To achieve the above objective, the bicycle clamping device of the present invention comprises: a tube assembly, having a first tube and a second tube, wherein the first tube has a first positioning portion and a first connecting portion at both ends, and the second tube is pivotally disposed inside the first tube and has one end protruding outward from the first tube; a first quick-release assembly, connected to the first connecting portion of the first tube and having a first transmission shaft and a first handle, wherein the first transmission shaft has one end pivotally connected to the first handle and the other end inserted inside the second tube, and the first transmission shaft is rotatable along with rotation of the first handle; a positioning assembly, having a second positioning portion for providing mutual positioning with the first positioning portion of the first tube, the positioning assembly being movable synchronously with the first transmission shaft; a clamping assembly, mounted to one side of the second tube, wherein the first transmission shaft drives synchronous rotation of the second tube and the clamping assembly when the first handle is rotated; and a stand assembly, pivotally mounted to a bottom side of the tube assembly.

### BRIEF DESCRIPTION OF THE DRAWINGS

FIG. 1 is an exploded perspective schematic view of the present invention.

FIG. 2 is an assembled perspective schematic view of the present invention.

FIG. 3 is a cross-sectional view of the present invention taken along III-III of FIG. 2.

FIG. 4 is a schematic view for illustrating the use of the present invention according to FIG. 2.

FIG. 5 is a cross-sectional view of the present invention taken along V-V of FIG. 4.

FIG. 6 is a schematic view of the use state of the tube assembly and the positioning assembly of the present invention being separate and the clamping assembly being rotated.

FIG. 7 is a schematic view of the use state of the tube assembly and the positioning assembly of the present invention not being separate and the clamping assembly being rotated.

FIG. 8 is a schematic view of the use state of clamping the bicycle seat tube according to the present invention.

FIG. 9 is a schematic view of the use state of clamping the bicycle top tube according to the present invention.

FIG. 10 is a schematic view of the clamping space of the clamping assembly according to the present invention being in unadjusted state.

FIG. 11 is a schematic view of the clamping space of the clamping assembly according to the present invention being in adjusted state.

FIG. 12 is an assembled perspective schematic view of another embodiment of the present invention.

### DETAILED DESCRIPTION OF THE PREFERRED EMBODIMENT

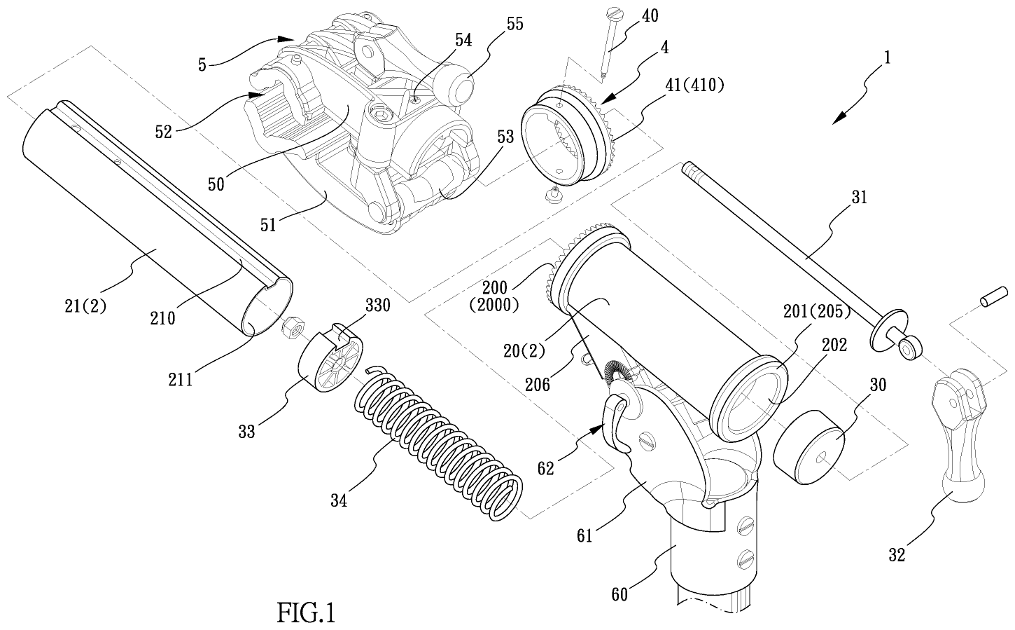

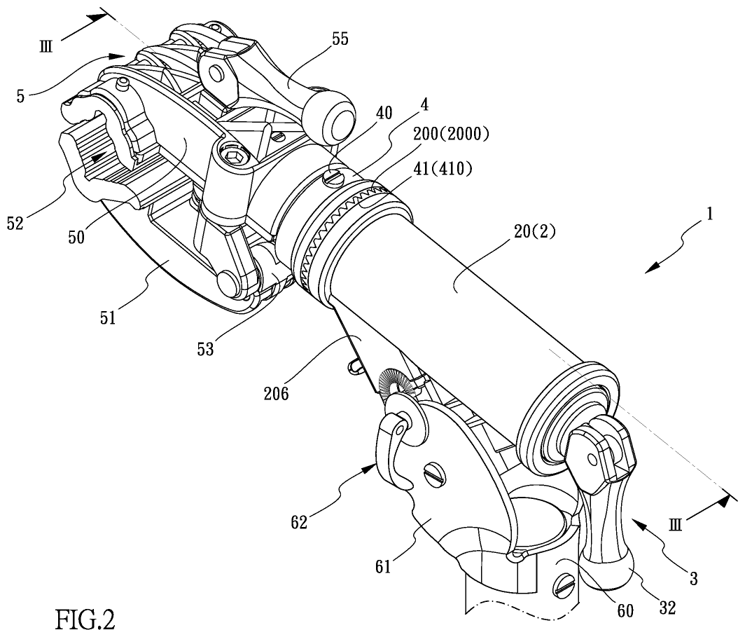

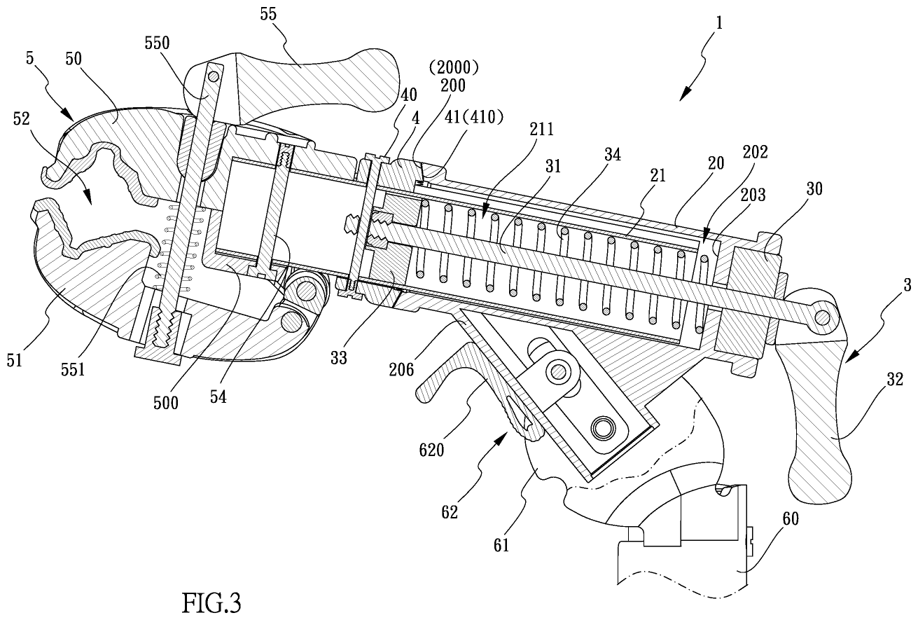

Please refer to FIGS. 1 through 12 for a detailed explanation of the exploded view of the bicycle clamping device of the present invention in accordance with the best embodiment. The bicycle clamping device 1 according to the present invention includes a tube assembly 2 having a first tube 20 and a second tube 21. The first tube 20 has a first positioning portion 200 and a first connecting portion 201 at both ends, and a first inner space 202 with a closed portion 203 and an aperture 204 at both ends. The first connecting portion 201 of the first tube 20 has a recessed accommodating groove 205 and is not communicated with the first inner space 202 due to the closed portion 203. The second tube 21 is pivotally disposed inside the first inner space 202 of the first tube 20, with one end adjacent to the closed portion 203 and the other end protruding outward from the first tube 20 through the aperture 204. The second tube 21 has a tube surface with a recessed limiting rib 210 and a second inner space 211.

The bicycle clamping device 1 further includes a first quick-release assembly 3, having a connecting member connected to the first connecting portion 201 of the first tube 20. The first quick-release assembly 3 further has a first transmission shaft 31, a first handle 32, a pressing member 33, and a first elastic member 34. The first transmission shaft 31 has one end pivotally connected to the first handle 32 and the other end inserted through the connecting member 30 and into the second inner space 211 of the second tube 21. The pressing member 33 is assembled to an end of the first transmission shaft 31 and has a limiting groove 330 corresponding to the limiting rib 210 of the second tube 21. The first elastic member 34 is sleeved on the first transmission shaft 31, with one end abutting against the pressing member 33 and the other end abutting against the closed portion 203.

The bicycle clamping device 1 further includes a positioning assembly 4, having a first fixing member 40 and a second positioning portion 41. The second positioning portion 41 and the first positioning portion 200 of the first tube 20 provide mutual positioning. The first fixing member 40 is longitudinally inserted through the positioning assembly 4 and the second tube 21 and fastened to the first transmission shaft 31, allowing synchronous movement of the positioning assembly 4 with the first transmission shaft 31. In this embodiment, the first positioning portion 200 and the second positioning portion 41 have a first tooth surface 2000 and a second tooth surface 410 engaged with each other.

The bicycle clamping device 1 further includes a clamping assembly 5, having an upper clamping portion 50, a lower clamping portion 51, and a clamping space 52 with a space size adjustable by the upward-downward pivoting of the lower clamping portion 51. The upper clamping portion 50 and the lower clamping portion 51 have corresponding pivot components 53. Furthermore, the upper clamping portion 50 has a fixed seat 500 fixedly connected to the second tube 21. By inserting a second fixing member 54 through the fixed seat 500 and the second tube 21 and eventually fastening the second fixing member 54 to the upper clamping portion 50, the clamping assembly 5 is mounted to one side of the second tube 21 and is movable synchronously with the second tube 21, the first transmission shaft 31, and the first handle 32. When the first handle 32 is rotated, the first transmission shaft 31, the second tube 21 and the clamping assembly 5 are driven to coaxial rotation. In addition, a second handle 55 is pivotally disposed at the middle of the upper clamping portion 50 and pivotally connected to an adjusting member 550. The adjusting member 550 is inserted downwardly through the upper clamping portion 50 and fixedly connected to the lower clamping portion 51. When the second handle 55 is pulled upward, the adjusting member 550 moves downwards, resulting in downward pivot motion of the lower clamping portion 51. This in coordination with extension and contraction of a second elastic member 551 on the adjusting member 550 can change the size of the clamping space 52 of the clamping assembly 5 and enable the adjustment in the size of the clamping space 52 according to different tube diameters of bicycles B, achieving optimal clamping effect.

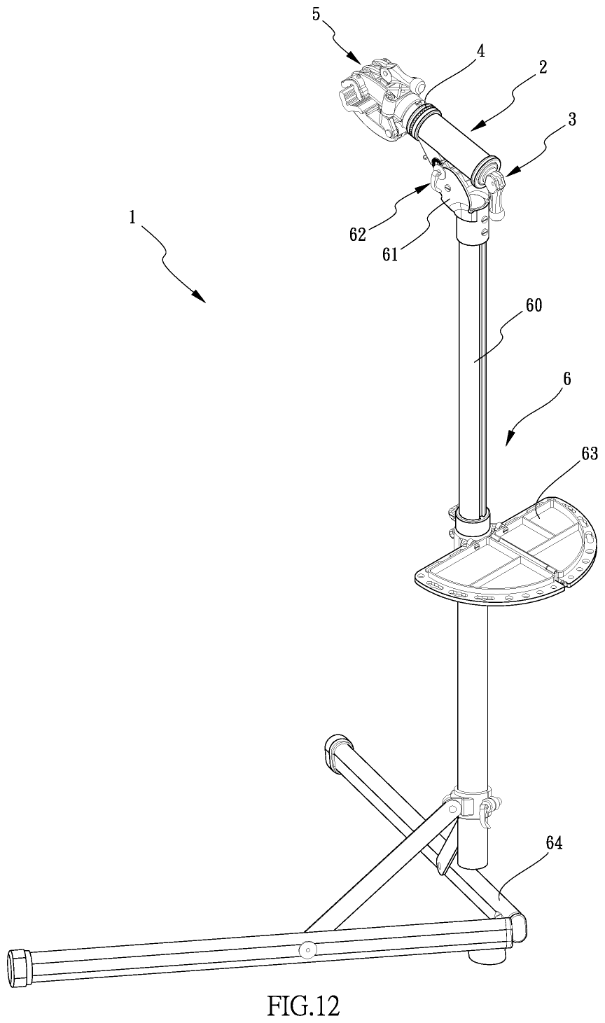

The bicycle clamping device 1 further includes a stand assembly 6, having an extendable tube set 60 and a pivot joint 61 at the top of the extendable tube set 60. The first tube 20 of the tube assembly 2 further has a pivotally connecting tube 206. The pivot joint 61 of the extendable tube set 60 and the pivotally connecting tube 206 of the first tube 20 are pivotally connected with each other through a second quick-release assembly 62, which has a handle 620. Additionally, the extendable tube set 60 is equipped with a tool placement tray 63 (for placing maintenance tools) at a suitable position thereof and a support base 64 at the bottom (as shown in FIG. 12). In this embodiment, pulling the handle 620 of the second quick-release assembly 62 toward one side can rotate the pivot joint 61 at the top of the extendable tube set 60 downwards, resulting in a folded state for easy carrying without taking up space.

Furthermore, the assembled structure of the bicycle clamping device 1 of the present invention in accordance with the best embodiment is further explained.

First, the second tube 21 is pivotally assembled in the first inner space 202 of the first tube 20, with one end of the second tube 21 protruding outward from the first tube 20 through the aperture 204. Then, the first transmission shaft 31 of the first quick-release assembly 3 is inserted into the second inner space 211 of the second tube 21. One end of the first transmission shaft 31 is connected to the pressing member 33, and the pressing member 33 is limited by the limiting groove 330 and the limiting rib 210 of the second tube 21. The first elastic member 34 is sleeved on the first transmission shaft 31, with both ends abutting against the pressing member 33 and the closed portion 203 of the first inner space 202, respectively. Afterwards, the second positioning portion 41 of the positioning assembly 4 is disposed correspondingly to the first positioning portions 200 of the first tube 20 so that the positioning assembly 4 is engaged with the first tube 20 through the first tooth surface 2000 and the second tooth surface 410. Then, the first fixing member 40 is longitudinally inserted through the positioning assembly 4 and the second tube 21 and fastened to the first transmission shaft 31, allowing synchronous movement of the positioning assembly 4 and the first transmission shaft 31. Next, the fixed seat 500 of the upper clamping portion 50 of the clamping assembly 5 is mounted to one side of the second tube 21, with the second fixing member 54 being inserted through the fixed seat 500 and the second tube 21 and eventually fixed to the upper clamping portion 50. This creates synchronic movement relationship among the clamping assembly 5, the second tube 21, the first transmission shaft 31 and the first handle 32, and makes the size of the clamping space 52 adjustable by the upper clamping portion 50 and the lower clamping portion 51 through the pivot components 53. When the first handle 32 is rotated, the first transmission shaft 31, the second tube 21, and the clamping assembly 5 are driven to coaxial rotation. Finally, the pivotally connecting tube 206 of the tube assembly 2 is detachably and pivotally mounted to the pivot joint 61 at the top of the extendable tube set 60 of the stand assembly 6 through the second quick-release assembly 62.

Continuing, further explanation is provided regarding the use state of the bicycle clamping device 1 in accordance with the best embodiment.

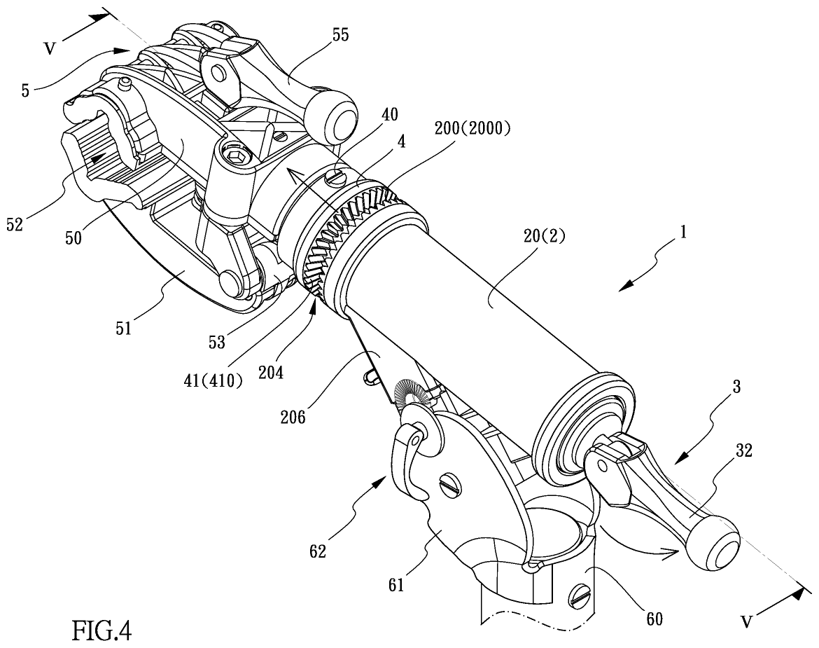

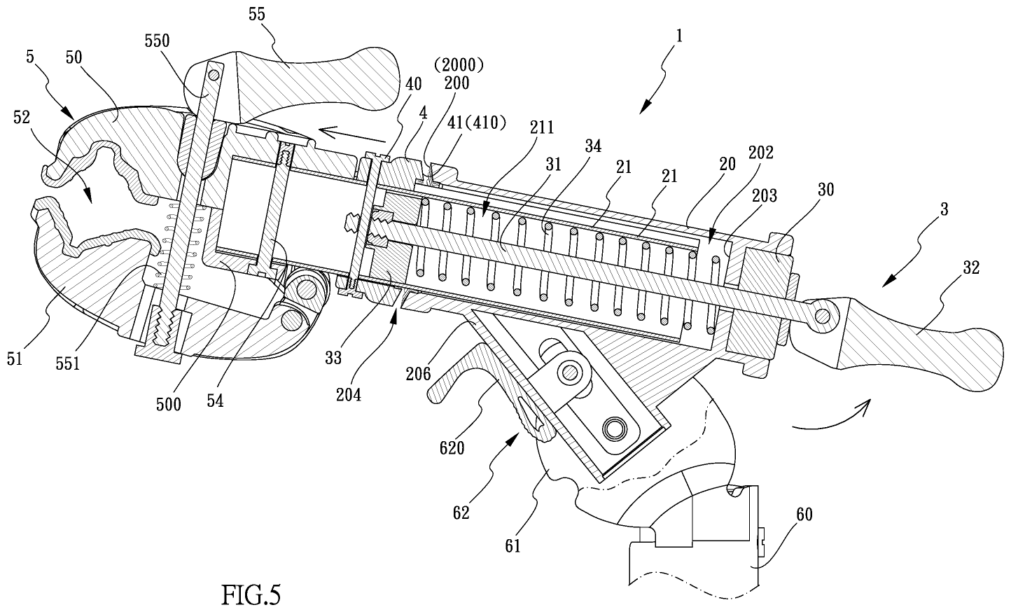

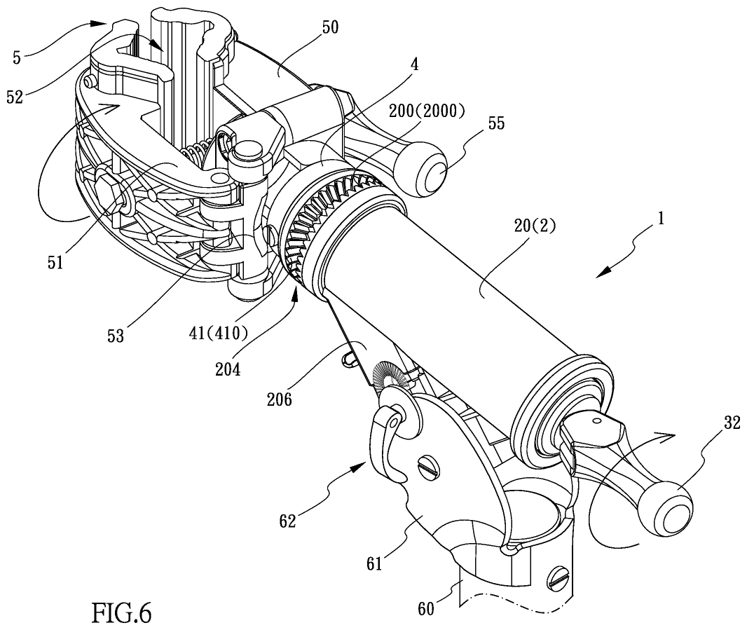

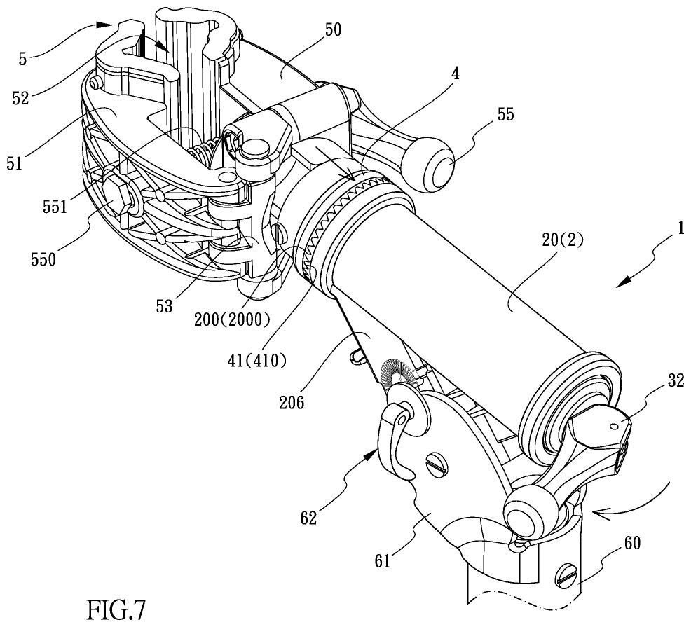

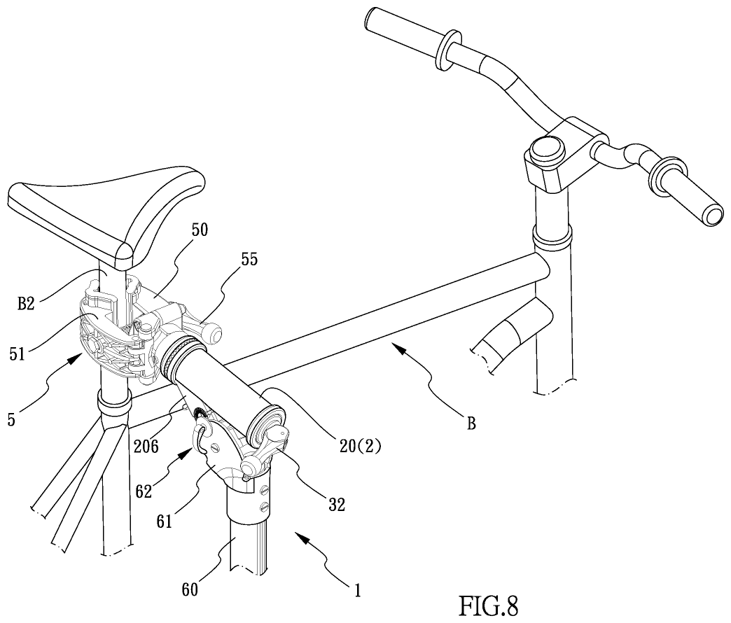

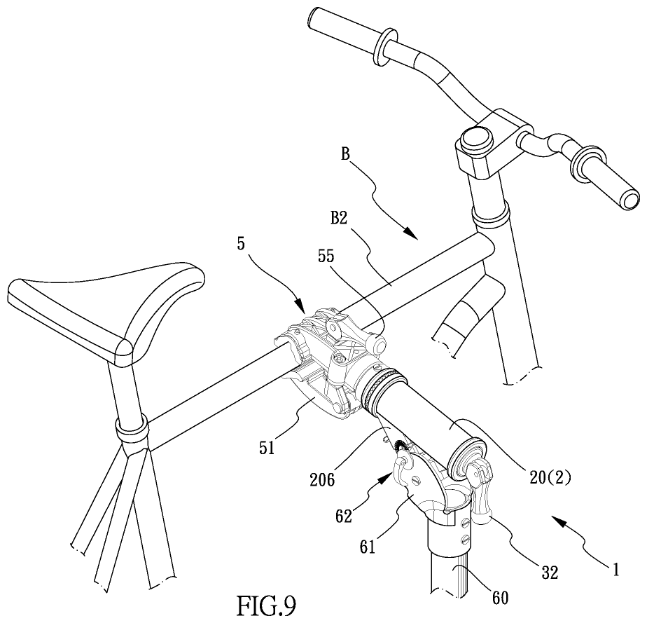

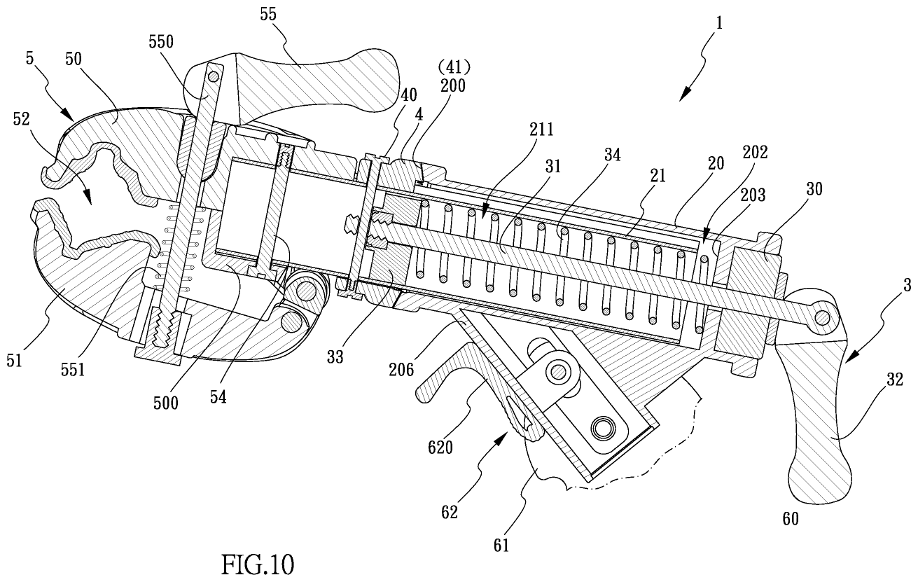

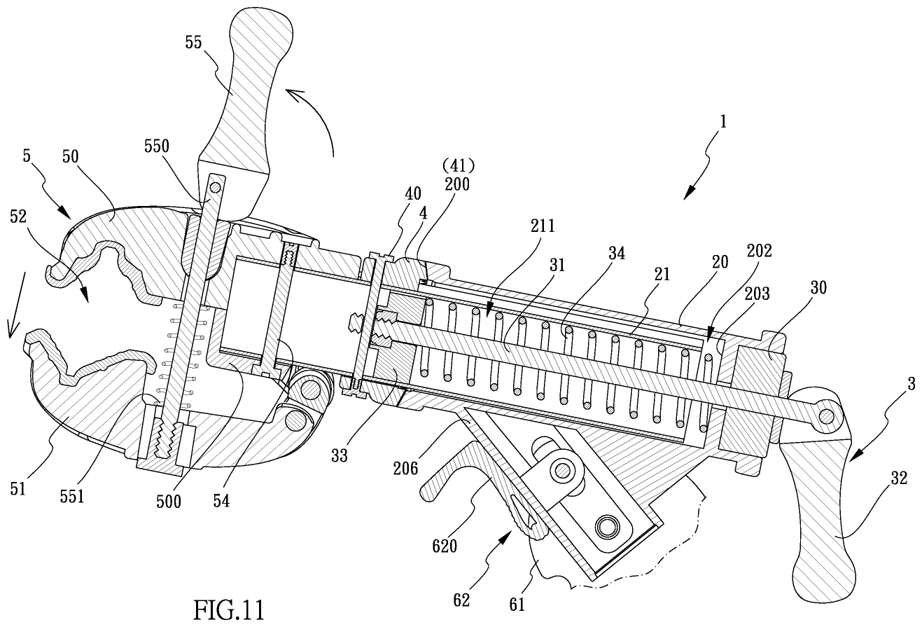

First, the support base 64 of the stand assembly 6 is placed on the ground, and the pivot joint 61 at the top is pivotally connected to the pivotally connecting tube 206 of the first tube 20 through the second quick-release assembly 62, with the length of the extendable tube set 60 adjustable in the up-down direction. Then, the first handle 32 of the first quick-release assembly 3 is pulled upward (as shown in FIG. 4), causing the first transmission shaft 31 pivotally connected to the first handle 32 to move forward, and the first elastic member 34 on the first transmission shaft 31 to release elastically. This pushes the pressing member 33, the first fixing member 40, and the positioning assembly 4 forward in a synchronous manner (as shown in FIG. 5). As a result, the second positioning portion 41 of the positioning assembly 4 separates from the first positioning portion 200 of the first tube 20. When the second positioning portion 41 separates from the first positioning portion 200, the clamping assembly 5 rotates along with the first handle 32 (as shown in FIG. 6) due to the coaxial rotation configuration between the clamping assembly 5 and the first handle 32. Once the clamping assembly 5 rotates to an appropriate position, the first handle 32 of the first quick-release assembly 3 can be returned to its original position, causing the second positioning portion 41 of the positioning assembly 4 to engage with the first positioning portion 200 of the first tube 20 (as shown in FIG. 7). Meanwhile, the clamping assembly 5 cannot rotate along with the first handle 32. For example, when the clamping assembly 5 needs to clamp the seat tube B1 of the bicycle B, the clamping assembly 5 can be rotated into a transverse state by rotating the first handle 32, and then the seat tube B1 can be clamped by the clamping space 52 (as shown in FIG. 8). When the clamping assembly 5 needs to clamp the top tube B2 of the bicycle B, the clamping assembly 5 can be rotated into a longitudinal state by rotating the first handle 32, and then the top tube B2 can be clamped by the clamping space 52 (as shown in FIG. 9). Additionally, the clamping assembly 5 can adjust the size of the clamping space 52 by pulling the second handle 55 and controlling the downward or upward pivoting of the lower clamping portion 51 by the adjusting member 550 (as shown in FIGS. 10 and 11) to achieve variable clamping effects of the clamping assembly 5 for different tube diameters.

In other words, the technical method of the present invention involves controlling the transition of the first tube 20 and the positioning assembly 4 from their original engaged state to a separate state by pulling the first handle 32 of the first quick-release assembly 3 and then rotating the first handle 32 to drive synchronic rotation of the clamping assembly 5 through the coaxial rotation configuration of the first handle 32 and the clamping assembly 5, thereby achieving rapid clamping the object to be fixed and improving maintenance efficiency.

What is claimed is:

1. A bicycle clamping device, comprising:
a tube assembly, having a first tube and a second tube, wherein the first tube has a first positioning portion and a first connecting portion at both ends, and the second tube is pivotally disposed inside the first tube and has one end protruding outward from the first tube;
a first quick-release assembly, connected to the first connecting portion of the first tube and having a first transmission shaft and a first handle, wherein the first transmission shaft has one end pivotally connected to the first handle and the other end inserted inside the second tube, and the first transmission shaft is rotatable along with rotation of the first handle;
a positioning assembly, having a second positioning portion for providing mutual positioning with the first positioning portion of the first tube, the positioning assembly being movable synchronously with the first transmission shaft;
a clamping assembly, mounted to one side of the second tube, wherein the first transmission shaft drives synchronous rotation of the second tube and the clamping assembly when the first handle is rotated; and
a stand assembly, pivotally mounted to a bottom side of the tube assembly.

2. The bicycle clamping device as claimed in claim 1, wherein the first tube has a first inner space with a closed portion and an aperture at both ends, respectively; the first connecting portion of the first tube is not communicated with the first inner space due to the closed portion and has a recessed accommodating groove; and the second tube is pivotally disposed in the first inner space of the first tube and has one end adjacent to the closed portion and the other end protruding outward from the first tube through the aperture.

3. The bicycle clamping device as claimed in claim 1, wherein the second tube has a tube surface with a recessed limiting rib and a second inner space; the first quick-release assembly further has a connecting member, a pressing member and a first elastic member; the first quick-release assembly is connected to the first connecting portion of the first tube through the connecting member; the first transmission shaft is inserted in the second inner space of the second tube and has one end assembled to the pressing member; the pressing member has a limiting groove corresponding to the limiting rib; and the first elastic member is sleeved on the first transmission shaft, with one end abutting against the pressing member and the other end abutting against the closed portion.

4. The bicycle clamping device as claimed in claim 1, wherein the first positioning portion of the first tube and the second positioning portion of the positioning assembly are separable through forward displacement of the first transmission shaft by pulling the first handle upward.

5. The bicycle clamping device as claimed in claim 1, wherein the positioning assembly further has a first fixing member longitudinally inserted through the positioning assembly and the second tube and fixed to the first transmission shaft, allowing synchronous movement of the positioning assembly with the second tube and the first transmission shaft through the first fixing member.

6. The bicycle clamping device as claimed in claim 1, wherein the clamping assembly has an upper clamping portion, a lower clamping portion, and a clamping space with a space size adjustable by the upward-downward pivoting of the lower clamping portion; and the upper clamping portion and the lower clamping portion have corresponding pivot components.

7. The bicycle clamping device as claimed in claim 6, wherein the upper clamping portion has a fixed seat fixedly connected to the second tube; and by inserting a second fixing member through the fixed seat and the second tube and eventually fastening the second fixing member to the upper clamping portion, the clamping assembly is mounted to one side of the second tube and is movable synchronously with the second tube, the first transmission shaft, and the first handle, allowing coaxial rotation of the first transmission shaft, the second tube and the clamping assembly when the first handle is rotated.

8. The bicycle clamping device as claimed in claim 6, wherein a second handle is pivotally disposed at a middle of the upper clamping portion and pivotally connected to an adjusting member; the adjusting member is inserted through the upper clamping portion and fixedly connected to the lower clamping portion; and the space size of the clamping space is adjustable by downward movement of the first transmission shaft and thus downward pivoting of the lower clamping portion when the second handle is pulled upward.

9. The bicycle clamping device as claimed in claim 1, wherein the first positioning portion and the second positioning portion have a first tooth surface and a second tooth surface engaged with each other.

10. The bicycle clamping device as claimed in claim 1, wherein the stand assembly has an extendable tube set and a pivot joint at a top of the extendable tube set; the first tube of the tube assembly further has a pivotally connecting tube; and the pivot joint of the extendable tube set and the pivotally connecting tube of the first tube are pivotally connected with each other through a second quick-release assembly.

11. The bicycle clamping device as claimed in claim 10, wherein the extendable tube set is equipped with a tool placement tray at a suitable position thereof and a support base at a bottom thereof.
